(19) United States
(12) Patent Application Publication
(10) Pub. No.: US 2016/0122620 A1
(43) Pub. Date: May 5, 2016

(54) Compositions and Methods for Servicing Subterranean Wells

(71) Applicant: SCHLUMBERGER TECHNOLOGY CORPORATION, Sugar Land, TX (US)

(72) Inventors: Diankui Fu, Kuala Lumpur (MY); Bipin Jain, Kuala Lumpur (MY); Soo Hui Goh, Kuala Lumpur (MY)

(21) Appl. No.: 14/943,633

(22) Filed: Nov. 17, 2015

Related U.S. Application Data
(63) Continuation-in-part of application No. 14/534,090, filed on Nov. 5, 2014.

(51) Int. Cl. C09K 8/52; E21B 33/14; E21B 37/00; C09K 8/536; C09K 8/467

(52) U.S. Cl. CPC C09K 8/52; C09K 8/536; C09K 8/467; E21B 37/00; E21B 33/14; C09K 2208/08

(57) ABSTRACT

Fluids containing surfactants and hydrophobic particles are effective media for cleaning non-aqueous fluids (NAFs) out of a subterranean wellbore. The fibers and surfactants are may be added to a drilling fluid, a spacer fluid, a sacrificial spacer fluid, a chemical wash, a cement slurry or combinations thereof. NAFs, such as an oil-base mud or a water-in-oil emulsion mud, are attracted to the fibers as the treatment fluid circulates in the wellbore.

### CROSS REFERENCE TO RELATED APPLICATIONS

This application is a continuation-in-part of U.S. patent application Ser. No. 14/534,090 that was filed on Nov. 5, 2014, which is hereby incorporated by reference in its entirety.

### BACKGROUND

The statements in this section merely provide background information related to the present disclosure and may not constitute prior art.

This disclosure relates to compositions and methods for removing NAFs from a subterranean wellbore.

During the construction of subterranean wells, it is common, during and after drilling, to place a tubular body in the wellbore. The tubular body may comprise drillpipe, casing, liner, coiled tubing or combinations thereof. The purpose of the tubular body is to act as a conduit through which desirable fluids from the well may travel and be collected. The tubular body is normally secured in the well by a cement sheath. The cement sheath provides mechanical support and hydraulic isolation between the zones or layers that the well penetrates. The latter function prevents hydraulic communication between zones that may result in contamination. For example, the cement sheath blocks fluids from oil or gas zones from entering the water table and contacting drinking water. In addition, to optimize a well's production efficiency, it may be desirable to isolate, for example, a gas-producing zone from an oil-producing zone. The cement sheath achieves hydraulic isolation because of its low permeability. In addition, intimate bonding between the cement sheath and both the tubular body and borehole may prevent leaks.

The cement sheath may be placed in the annular region between the outside of the tubular body and the subterranean borehole wall by pumping the cement slurry down the interior of the tubular body, which in turn exits the bottom of the tubular body and travels up into the annulus. The cement slurry may also be placed by the “reverse cementing” method, whereby the slurry is pumped directly down into the annular space. During the cementing process, the cement slurry is frequently preceded by a spacer fluid or chemical wash to prevent commingling with drilling fluid in the wellbore. These fluids also help clean the tubular-body and formation surfaces, promoting better cement bonding and zonal isolation. The cement slurry may also be followed by a displacement fluid such as water, a brine or drilling fluid. This fluid may reside inside the tubular body after the cementing process is complete. A complete description of the cementing process and the use of spacer fluids and chemical washes is presented in the following publications. Piot B and Cuvillier G: “Primary Cementing Techniques,” in Nelson E B and Guillot D: Well Cementing-2nd Edition, Houston, Schlumberger (2006) 459-501. Daccord G, Guillot D and Nilsson F: “Mud Removal,” in in Nelson E B and Guillot D: Well Cementing-2nd Edition, Houston, Schlumberger (2006) 143-189.

Most primary cementing operations employ a two-plug cement placement method (see FIGS. 1A-1D). After drilling through an interval to a desired depth, the drillpipe is removed, leaving the borehole 101 filled with drilling fluid 102. A casing string 103 is lowered to the bottom of the borehole, forming an annulus 104 between the casing string and the borehole (FIG. 1A). The bottom end of the casing string is protected by a guide shoe or float shoe 105. Both shoes are tapered, commonly bullet-nosed devices that guide the casing toward the center of the hole to minimize contact with rough edges or washouts during installation. The guide shoe differs from the float shoe in that the former lacks a check valve. The check valve can prevent reverse flow, or U-tubing, of fluids from the annulus into the casing. Centralizers 106 are placed along casing sections to help prevent the casing from sticking while it is lowered into the well. In addition, centralizers keep the casing in the center of the borehole to help ensure placement of a uniform cement sheath in the annulus between the casing and the borehole wall.

As the casing 103 is lowered into the well, the casing interior may fill with drilling fluid 102. The objectives of the primary cementing operation are to remove drilling fluid from the casing interior and borehole, place a cement slurry in the annulus and fill the casing interior with a displacement fluid such as drilling fluid, brine or water.

Cement slurries and drilling fluids are often chemically incompatible. Commingling these fluids may result in a thickened or gelled mass at the interface that would be difficult to remove from the wellbore, possibly preventing placement of a uniform cement sheath throughout the annulus. Therefore, a chemical and physical means may be employed to maintain fluid separation. Chemical washes 107 and spacer fluids 108 may be pumped after the drilling fluid and before the cement slurry 109 (FIG. 1B). These fluids have the added benefit of cleaning the casing and formation surfaces, which helps achieve good cement bonding.

Wiper plugs are elastomeric devices that provide a physical barrier between fluids pumped inside the casing. A bottom plug 110 separates the cement slurry from the drilling fluid, and a top plug 111 separates the cement slurry from a displacement fluid 112 (FIG. 1C). The bottom plug has a membrane 113 that ruptures when it lands at the bottom of the casing string, creating a pathway through which the cement slurry may flow into the annulus. The top plug 111 does not have a membrane; therefore, when it lands on top of the bottom plug, hydraulic communication is severed between the casing interior and the annulus (FIG. 1D). After the cementing operation, engineers wait for the cement to cure, set and develop strength—known as waiting on cement (WOC). After the WOC period additional drilling, perforating or other operations may commence.

Another purpose of a bottom plug is to scrape stationary drilling fluid or drilling fluid solids from the casing interior, leaving a clean casing interior surface and pushing the drilling fluid material out of the casing and into the annulus.

There are certain primary cementing situations where it is not possible to launch a bottom plug as a separator between the cement slurry and the fluids that have been previously pumped into the wellbore. Such operations include two-stage cement jobs and liner cementing. If a bottom plug is not present, a layer of drilling fluid and drilling fluid solids may remain along the interior casing surface. As the cement slurry passes by the casing surface, drilling fluid material may become incorporated in (or commingle with) the cement slurry, and such contamination may cause chemical and rheological difficulties.

Furthermore, as the top plug travels down the casing interior, it wipes the casing surface clean and the drilling fluid material that may accumulate below the top plug could further contaminate the cement slurry. At the end of displacement, most of this contaminated cement slurry may come to rest in the annular space between the float collar and float shoe, thereby severely compromising the mechanical properties of the cement.

Drilling-fluid removal and wellbore cleaning may be challenging when the well has been drilled with NAFs. In the art of well cementing, NAFs may be oil-base muds or water-in-oil emulsions. Conventionally, operators employ water-base spacer fluids or chemical washes comprising surfactants that render the fluids compatible with NAFs. In the context of well cementing, fluids are compatible when no negative rheological effects such as gelation occur upon their commingling. Such effects may hinder proper fluid displacement, leaving gelled fluid in the wellbore and reducing the likelihood of achieving proper zonal isolation. Ideally, the spacer fluid, chemical wash or both will completely remove the NAF and leave casing and formation surfaces in the annulus water wet. Water-wet surfaces may promote intimate bonding between the cement sheath and casing and formation surfaces.

### SUMMARY

The present disclosure describes improved compositions for removing NAFs from wellbore and tubular-body surfaces. Aqueous fluids including spacer fluids, sacrificial spacer fluids, chemical washes, drilling fluids and cement slurries are provided that are compatible with NAFs and have the ability to remove them from a wellbore during a cementing treatment. In this application, a sacrificial spacer fluid is defined as a spacer fluid that is left in the well after a cementing operation. Such a condition may occur when the well operator wishes to remove the NAF from the well and leave a portion of the casing/wellbore annulus uncemented.

In an aspect, embodiments relate to compositions. The compositions comprise water, an inorganic cement, one or more surfactants and hydrophobic solids.

In a further aspect, embodiments relate to methods for cleaning a wellbore in a subterranean well whose surfaces are coated with a non-aqueous fluid (NAF). An aqueous treatment fluid is provided that comprises water, one or more surfactants and hydrophobic solids. The treatment fluid is circulated in the wellbore, then removed from the wellbore. A NAF has been employed as a drilling fluid.

In yet a further aspect, embodiments relate to methods for cementing a subterreanean well having a wellbore that has been drilled with a NAF. A casing string is placed inside the wellbore, thereby forming an annulus between an outer surface of the casing string and a wellbore wall. An aqueous treatment fluid is provided that comprises water, one or more surfactants and hydrophobic solids. The treatment fluid is pumped into and through an interior of the casing string, wherein the treatment fluid is not preceded by a bottom plug. The treatment fluid is then removed from the interior of the casing string. A cement slurry is then provided and placed in the annulus between the outer surface of the casing string and the wellbore wall.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

FIGS. 1A-1D depict the sequence of events that take place during a primary cementing operation that employs the two-plug method.

FIG. 2 shows a diagram illustrating the ability of hydrophobic fibers and surfactants to remove NAFs from casing and formation surfaces in a wellbore.

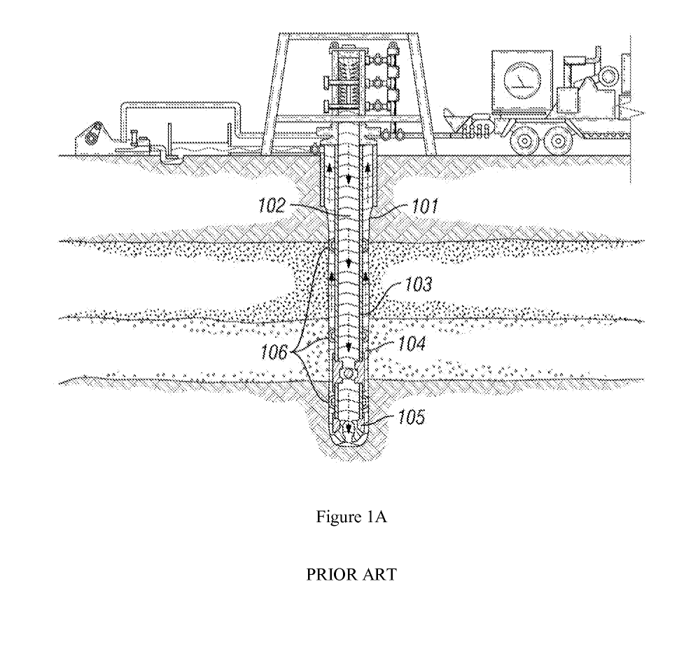

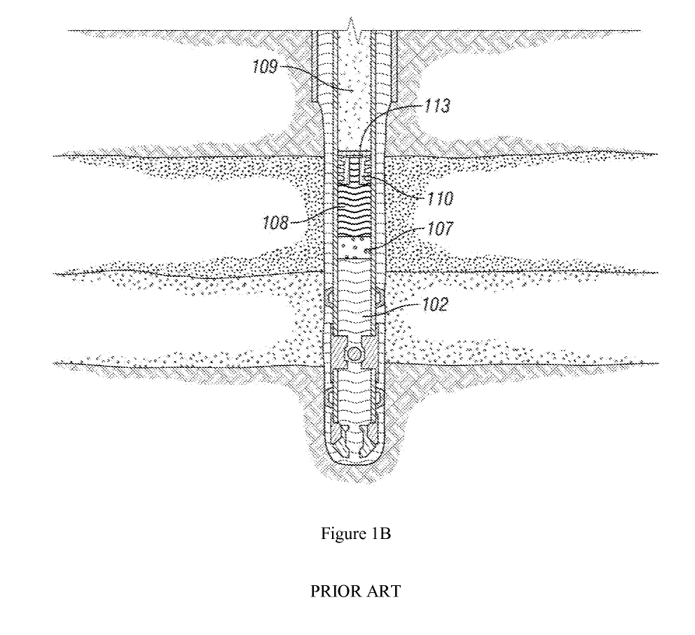

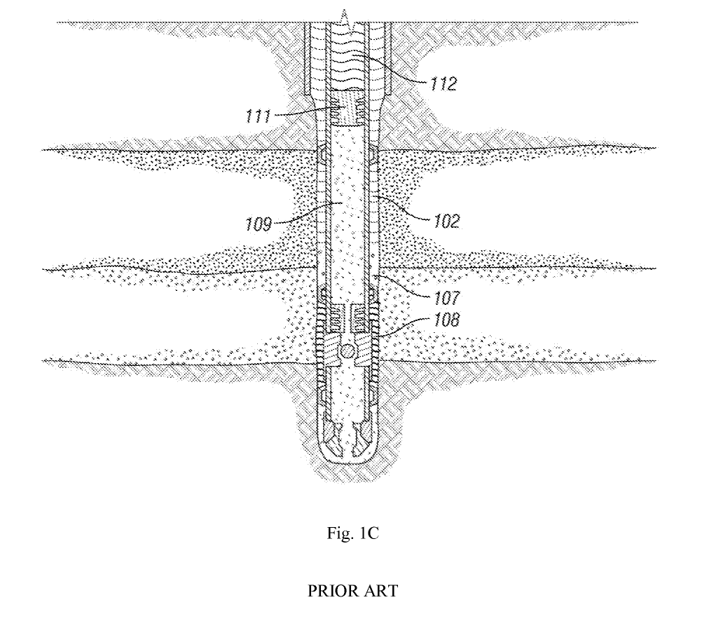

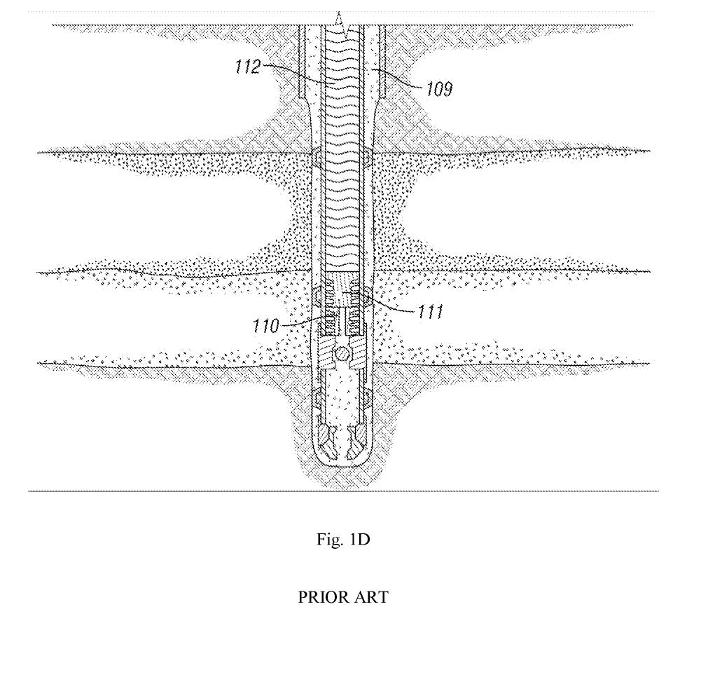

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. The description and examples are presented solely for the purpose of illustrating the preferred embodiments should not be construed as a limitation to the scope and applicability of the disclosed embodiments. While the compositions of the present disclosure are described herein as comprising certain materials, it should be understood that the composition could optionally comprise two or more chemically different materials. In addition, the composition can also comprise some components other than the ones already cited.

Embodiments relate to compositions and methods for cleaning surfaces coated with a NAF. Such surfaces include a borehole in a subterranean well whose surfaces are coated with a NAF.

In an aspect, embodiments relate to compositions. The compositions comprise water, an inorganic cement, one or more surfactants and hydrophobic solids. The water may be fresh water, produced water, connate water, sea water or brines. The inorganic cement may comprise portland cement, calcium aluminate cement, lime/silica blends, fly ash, blast furnace slag, zeolites, cement kiln dust, geopolymers or chemically bonded phosphate ceramics or combinations thereof. The cement slurry may further comprise additives comprising accelerators, retarders, extenders, weighting agents, fluid-loss additives, dispersants, nitrogen, air, gas generating agents, antifoam agents or lost circulation agents or combinations thereof.

In a further aspect, embodiments relate to methods for cleaning a wellbore in a subterranean well whose surfaces are coated with a NAF. In this application, the surfaces in the wellbore include both the casing surfaces and the formation rock surfaces. An aqueous treatment fluid is provided that comprises water, one or more surfactants and hydrophobic solids. The treatment fluid is circulated in the wellbore, then removed from the wellbore. The surfaces may comprise the borehole wall, tubular body surfaces or both. The circulation of the treatment fluid may remove the NAF, filter cake or both from the tubular body and borehole-wall surfaces, and could also leave them water wet. The tubular body may be drill pipe, casing or tubing or combinations thereof. A NAF has been employed as a drilling fluid.

In yet a further aspect, embodiments relate to methods for cementing a subterreanean well having a wellbore that has been drilled with a NAF. A casing string is placed inside the wellbore, thereby forming an annulus between an outer surface of the casing string and a wellbore wall. An aqueous treatment fluid is provided that comprises water, one or more surfactants and hydrophobic solids. The treatment fluid is pumped into and through an interior of the casing string, wherein the treatment fluid is not preceded by a bottom plug. The treatment fluid is then removed from the interior of the casing string. A cement slurry is then provided and placed in the annulus between the outer surface of the casing string and the wellbore wall.

The aqueous treatment fluid volume may be at least one casing volume. Or, the volume may also be adjusted such that the contact time (i.e., the period of time that a point in the casing or wellbore is exposed to the treatment fluid) is at least 15 minutes.

The surfaces may comprise the borehole wall, tubular body surfaces or both. The circulation of the treatment fluid may remove the NAF, filter cake or both from the tubular body and borehole-wall surfaces, and may render leaving them water wet. The tubular body may be drill pipe, casing or tubing or combinations thereof.

The cement slurry may comprise portland cement, calcium aluminate cement, lime/silica mixtures, fly ash, blast furnace slag, zeolites, geopolymers or chemically bonded phosphate ceramics or combinations thereof. The cement slurry may further comprise additives comprising accelerators, retarders, extenders, weighting agents, fluid-loss additives, dispersants, nitrogen, air, gas generating agents, antifoam agents or lost circulation agents or combinations thereof.

The hydrophobic solids may comprise polyester fibers, polyalkene fibers, acrylic fibers, amide fibers, imide fibers, carbonate fibers, diene fibers, ester fibers, ether fibers, fluorocarbon fibers, olefin fibers, styrene fibers, vinyl acetal fibers, vinyl chloride fibers, vinylidene chloride fibers, vinyl ester fibers, vinyl ether fibers, vinyl ketone fibers, vinylpyridine fibers, vinylpyrrolidone fibers or polyamide fibers or combinations thereof. The polyester fibers may be derived from polylactic acid. The polyester fibers may comprise polyglycolide or polyglycolic acid (PGA), polylactic acid (PLA), polycaprolactone (PCL), polyhydroxyalkanoate (PHA), polyhydroxybutyrate (PHB), polyethylene adipate (PEA), polybutylene succinate (PBS), poly(3-hydroxybutyrate-co-3-hydroxyvalerate) (PHBV), polyethylene terephthalate (PET), polybutylene terephthalate (PBT), polytrimethylene terephthalate (PTT) or Polyethylene naphthalate (PEN) or combinations thereof. The polyester fibers may comprise Short Cut PLA Staple, available from Fiber Innovation Technology, Johnson City, Tenn., USA.

The polyamide fibers may comprise NYLON-6, NYLON-11, NYLON-12, NYLON-6,6, NYLON-4,10, NYLON-5,10, PA6/66 DuPont ZYTEL [21]), PA6/6T BASF ULTRAMID T [22]), PA6I/6T DuPont SELAR PA [23], PA66/6T DuPont ZYTEL HTN or PA4T DSM Four Tii or combinations thereof.

The fibers may have a diameter larger than 1 micron but smaller than 50 microns, or smaller than 40 microns, or smaller than 30 microns. Specifically, the fibers may have a diameter between 1 micron and 50 microns, or 5 microns and 30 microns or 10 microns and 15 microns. The fibers may have a length longer than 1 mm but shorter than 30 mm, or 20 mm, or 10 mm. Specifically, the fibers may have a length between 2 mm and 20 mm, or 4 mm and 12 mm or 6 mm and 8 mm. The fibers may be present at a concentration between 0.6 kg/m³ and 14 kg/m³, or 1.2 kg/m³ and 10 kg/m³ or 2 kg/m³ and 8 kg/m³.

For some aspects, the fibers may be crimped. For this disclosure, crimps are defined as undulations, waves or a succession of bends, curls and waves in a fiber strand. The crimps may occur naturally, mechanically or chemically. Crimp has many characteristics, among which are its amplitude, frequency, index and type. For this disclosure, crimp is characterized by a change in the directional rotation of a line tangent to the fiber as the point of tangent progresses along the fiber. Two changes in rotation constitute one unit of crimp. Crimp frequency is the number of crimps or waves per unit length of extended or straightened fiber. Another parameter is the crimping ratio, K1 (Eq. 1).

$$K 1 = \frac{Lv - Lk}{Lv} , \qquad ( Eq . 1 )$$

where Lk is the length of the crimped fiber in the relaxed, released state; and Lv is the length of the same fiber in the stretched state (i.e., the fiber is practically rectilinear without any bends).

For this disclosure, the fibers may have a crimp frequency between 1/cm and 6/cm, or 1/cm and 5/cm or 1/cm and 4/cm. The K1 value may be between 2 and 15, or between 2 and 10 or between 2 and 6.

The surfactants may comprise anionic surfactants, cationic surfactants, nonionic surfactants or zwitterionic surfactants or combinations thereof. The anionic surfactants may comprise sulfates, sulfonates, phosphates or carboxylates or combinations thereof. The anionic surfactants may comprise ammonium lauryl sulfate, sodium lauryl sulfate, sodium laureth sulfate, sodium myreth sulfate, dioctyl sodium sulfosuccinate, perfluorooctane sulfoantes, perfluorobutanesulfonates, alkylbenzene sulfonates, alkyl-aryl ether phosphates, alkyl ether phosphates, alkyl carboxylates, sarcosinates, perfluorononanoates, or perfluorooctanoates or combinations thereof. The cationic surfactants may comprise primary, secondary or tertiary amines, or quaternary ammonium salts or combinations thereof. The nonionic surfactants may comprise long chain alcohols, ethoxylated alcohols, polyoxyethylene glycol alkyl ethers, polyoxypropylene glycol alkyl ethers, glucoside alkyl ethers, polyoxyethylene glycol octylphenol ethers, polyoxyethylene glycol alklyphenol ethers, glycerol alkyl esters, polyoxyethylene glycol sorbitan alkyl esters, sorbitan alkyl esters, cocamide DEA, cocamide MEA, dodecyldimethylamine oxide, block copolymers of polyethylene glycol or polypropylene glycol, or polyethoxylated tallow amine or combinations thereof. The zwitterionic surfactants may comprise sultaines or betaines or combinations thereof. The surfactants may be present at a concentration between about 0.1 vol % and 50 vol %, or between 0.5 vol % and 30 vol %, or between 1 vol % and 10 vol %.

The aqueous fluid may comprise a drilling fluid, a spacer fluid, a sacrificial spacer fluid, a chemical wash or a cement slurry or a combination thereof. If the aqueous treatment fluid is a drilling fluid, it may be the drilling fluid that was used to drill the wellbore, or a second drilling fluid with different chemical or physical properties.

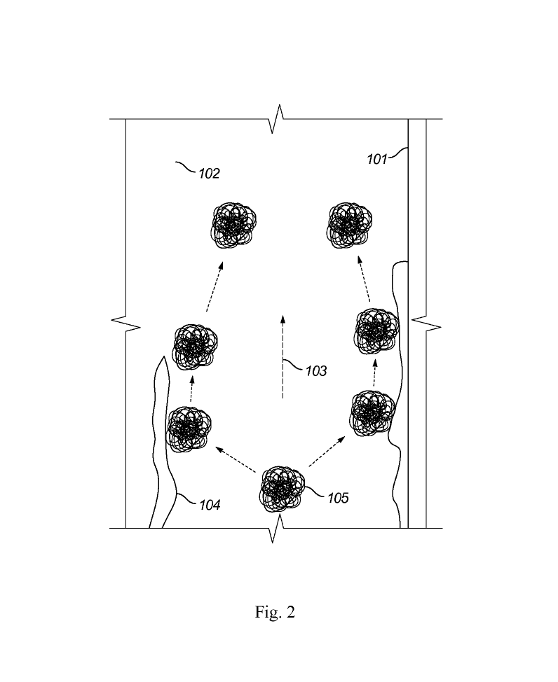

One non-limiting example of the method is illustrated in FIG. 2. Casing 101 is present in the wellbore, and a non-aqueous coating 104 is deposited on its surface. On the other side of the annular space, a non-aqueous coating 104 also is attached to the formation wall 102. The treatment fluid comprising surfactants and hydrophobic fibers 105 is flowing upward 103 in the annular space. The hydrophobic nature of the fibers and the presence of the surfactants cause the non-aqueous coating to be removed from the casing and formation surfaces as the treatment fluid travels up the annulus.

### EXAMPLES

The following examples serve to further illustrate the subject matter of the present application.

The following test method was employed in each of the following examples. A rotor test was conducted to evaluate the ability of treatment-fluid compositions to remove NAF from casing surfaces. The test equipment was a Chan 35™ rotational rheometer, available from Chandler Engineering, Tulsa, Okla., USA. The rheometer was equipped with two cups—one with an 85-mm diameter for tests conducted at 25° C. and 55° C., and one with a 50-mm diameter for tests conducted at 85° C. A closed rotor, 73.30 mm long and 40.70 mm in diameter, was employed to simulate the casing surface and provide an evaluation of test repeatability. Both rotors had a sand blasted stainless-steel surfaces with an average roughness of 1.4 μm.

The NAF was an 80/20 oil/water emulsion obtained from a field location. The NAF density was 1420 kg/m³ (11.8 lbm/gal). The surfactant was EZEFLO™ Surfactant, a blend of ethoxylated alcohols available from Schlumberger, Houston, Tex., USA. The fiber was Short Cut PLA Staple, available from Fiber Innovation Technology, Johnson City, Tenn., USA. The NAF was sheared at 6000 RPM in a Silverson mixer for 30 minutes. The NAF was then transferred to one of the Chan 35™ rheometer cups. A test rotor was weighted (w₀) and then lowered into the NAF to a depth of 50 mm. The rotor was then rotated within the NAF for one minute at 100 RPM and then left to soak in the NAF for 10 minutes. Next, the rotor was removed from the NAF and left to drain for two minutes. The bottom of the rotor was wiped clean and then weighed (w₁). The rotor was then remounted on the rheometer and immersed in a cup containing the treatment fluid such that the NAF layer was just covered by the treatment fluid. The rotor was rotated for 10 minutes at 60 RPM. The rotor was then removed from the treatment fluid and left to drain for two minutes. The bottom of the rotor was wiped clean and weighed (w₂). The NAF removal efficiency R was then determined by Eq. 2.

$$R ( \% ) = \frac{{w}_{1} - {w}_{2}}{{w}_{1} - {w}_{0}} \times 100 \qquad ( Eq . 2 )$$

The tests were repeated at least twice, and the results were averaged to obtain a final result. It is desirable to achieve an R value higher than 75%.

### EXAMPLE 1

Experiments were performed to evaluate the effect of fiber diameter on cleaning efficiency. The EZEFLO™ surfactant was present at a concentration of 23.8 vol % (1 gal/bbl). The fiber length was 6 mm, and the fiber concentration in the treatment fluid was 3.6 kg/m³ (1.25 lbm/bbl). The results are presented in Table 1. Fibers with diameters between 5 microns and 30 microns showed better cleaning efficiencies.

TABLE 1
Impact of fiber diameter on cleaning efficiency.

| Example | Fiber Diameter (micron) | R (%) |
|---|---|---|
| IA | 12 | 81.98 |
| 1B | 20 | 83.56 |
| 1C | 40 | 42.76 |

### EXAMPLE 2

Experiments were performed to evaluate the fiber geometry (i.e., straight or crimped) on cleaning efficiency. The EZEFLO™ surfactant was present at a concentration of 23.8 vol % (1 gal/bbl). The fiber length was 6 mm, and the fiber concentration in the treatment fluid was 3.6 kg/m³ (1.25 lbm/bbl). The results are presented in Table 2.

TABLE 2
Impact of fiber geometry on cleaning efficiency.

| Example | Fiber Shape | R (%) |
|---|---|---|
| 2A | Straight | 81.98 |
| 2B | Crimped (<4 crimps/cm; K1 < 6) | 95.52 |

### EXAMPLE 3

Experiments were performed to determine the effect of fiber concentration on cleaning efficiency. The EZEFLO™ surfactant was present at a concentration of 23.8 vol % (1 gal/bbl). The results are presented in Table 3. Fibers at concentrations above 3 kg/m³ showed better cleaning efficiencies. The upper limit of the fiber concentration can be adjusted according to the fluid design, but in general less than 10 kg/m³.

TABLE 3
Impact of fiber concentration on cleaning efficiency.

| | Fiber Concentration (kg/m³ | |
|---|---|---|
| Example | [lbm/bbl]) | R (%) |
| 3A | 1.4 [0.5] | 46.1 |
| 3B | 4.3 [1.25] | 86.3 |
| 3C | 7.1 [2.5] | 90.5 |

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

1. A composition, comprising:
(i) water;
(ii) an inorganic cement;
(iii) one or more surfactants; and
(iv) hydrophobic solids.

2. The composition of claim 1, wherein the solids comprise fibers, the fibers being selected from the group consisting of polyester fibers, polyalkene fibers, acrylic fibers, amide fibers, imide fibers, carbonate fibers, diene fibers, ester fibers, ether fibers, fluorocarbon fibers, olefin fibers, styrene fibers, vinyl acetal fibers, vinyl chloride fibers, vinylidene chloride fibers, vinyl ester fibers, vinyl ether fibers, vinyl ketone fibers, vinylpyridine fibers, vinylpyrrolidone fibers, polyamide fibers and combinations thereof.

3. The composition of claim 2, wherein the polyester fibers are derived from polylactic acid.

4. The composition of claim 2, wherein the fibers are crimped.

5. The composition of claim 2, wherein the fibers have a diameter between 1 micron and 50 microns, and a length between 2 mm and 20 mm.

6. The composition of claim 1, wherein the surfactants comprise anionic, cationic, nonionic or zwitterionic surfactants or combinations thereof.

7. A method for cleaning a wellbore in a subterranean well whose surfaces are coated with a non-aqueous fluid (NAF), comprising:
(i) providing an aqueous treatment fluid comprising water, one or more surfactants and hydrophobic solids;
(ii) circulating the treatment fluid in the wellbore; and
(iii) removing the treatment fluid from the wellbore, wherein the NAF has been employed as a drilling fluid.

8. The method of claim 7, wherein the solids comprise fibers, the fibers being selected from the group consisting of polyester fibers, polyalkene fibers, acrylic fibers, amide fibers, imide fibers, carbonate fibers, diene fibers, ester fibers, ether fibers, fluorocarbon fibers, olefin fibers, styrene fibers, vinyl acetal fibers, vinyl chloride fibers, vinylidene chloride fibers, vinyl ester fibers, vinyl ether fibers, vinyl ketone fibers, vinylpyridine fibers, vinylpyrrolidone fibers, polyamide fibers and combinations thereof.

9. The method of claim 8, wherein the polyester fibers are derived from polylactic acid.

10. The method of claim 8, wherein the fibers are crimped.

11. The method of claim 8, wherein the fibers have a diameter between 1 micron and 50 microns, and a length between 2 mm and 20 mm.

12. The method of claim 7, wherein the surfactants comprise anionic, cationic, nonionic or zwitterionic surfactants or combinations thereof.

13. The method of claim 7, wherein the aqueous fluid comprises a drilling fluid, a spacer fluid, a sacrificial spacer fluid, a chemical wash, or a cement slurry, or a combination thereof.

14. A method for cementing a subterranean well having a wellbore that has been drilled with a non-aqueous fluid (NAF), comprising:
(i) placing a casing string inside the wellbore, thereby forming an annulus between an outer surface of the casing string and a wellbore wall;
(ii) providing an aqueous treatment fluid comprising water, one or more surfactants and hydrophobic solids;
(iii) pumping the treatment fluid into and through an interior of the casing string, wherein the treatment fluid is not preceded by a bottom plug;
(iv) removing the treatment fluid from the interior of the casing string;
(v) providing a cement slurry; and
(vi) placing the slurry in the annulus between the outer surface of the casing string and the wellbore wall.

15. The method of claim 14, wherein the solids comprise fibers, the fibers being selected from the group consisting of polyester fibers, polyalkene fibers, acrylic fibers, amide fibers, imide fibers, carbonate fibers, diene fibers, ester fibers, ether fibers, fluorocarbon fibers, olefin fibers, styrene fibers, vinyl acetal fibers, vinyl chloride fibers, vinylidene chloride fibers, vinyl ester fibers, vinyl ether fibers, vinyl ketone fibers, vinylpyridine fibers, vinylpyrrolidone fibers, polyamide fibers and combinations thereof.

16. The method of claim 15, wherein the polyester fibers are derived from polylactic acid.

17. The method of claim 15, wherein the fibers are crimped.

18. The method of claim 15, wherein the fibers have a diameter between 1 micron and 50 microns, and a length between 2 mm and 20 mm.

19. The method of claim 14, wherein the surfactants comprise anionic, cationic or zwitterionic surfactants or combinations thereof.

20. The method of claim 14, wherein the aqueous fluid comprises a drilling fluid, a spacer fluid, a sacrificial spacer fluid, a chemical wash, or a cement slurry, or a combination thereof.
